(19) United States
(12) Patent Application Publication
(10) Pub. No.: US 2019/0184543 A1
(43) Pub. Date: Jun. 20, 2019

(54) MULTI-PRONGED HANDLE FOR A HAND TOOL

(71) Applicant: Sebastian Hart-Meyer, Concord, NH (US)

(72) Inventor: Sebastian Hart-Meyer, Concord, NH (US)

(21) Appl. No.: 15/842,708

(22) Filed: Dec. 14, 2017

(51) Int. Cl. B25G 1/10; B25B 23/16; B25B 23/00

(52) U.S. Cl. CPC B25G 1/102; B25B 15/04; B25B 23/0042; B25B 23/16

(57) ABSTRACT

The present disclosure generally relates to a handle for a hand tool. The handle comprises at least four prongs extending outwardly from a central point. An arcuate surface is disposed between each of the at least four prongs. A connection member extends outwardly from the central point perpendicularly in relation to the at least four prongs. The connection member may removably engage with the hand tool.

### FIELD OF THE DISCLOSURE

The present disclosure generally relates to hand tools, and more particularly, the present disclosure relates to a handle for a hand tool with multiple prongs.

### BACKGROUND

Hand tools generally provide a mechanical advantage to assist a user in performing a specific task. Generally, to perform a specific task, a requisite amount of force must be applied to the hand tool. For example, the user may place their hand around a handle of the hand tool, such as a screwdriver, and generate sufficient torque directed around the shaft of the screwdriver to provide enough rotational force to drive a screw into a suitable material.

However, many users of hand tools struggle to use hand tools. Some users may develop discomfort handling a hand tool, as the user may place strain on their wrist and fingers to correctly position their hands on the handle of the hand tool. Users with various skeletal and joint disorders or diseases, such as arthritis, may especially develop discomfort when using hand tools. Other users, such as those with insufficient finger and hand strength, for example, may struggle to generate enough torque to provide the sufficient force required to perform a task, such as to drive a screw into a material. Because of this, many users may be unable to properly use the hand tools to perform specific tasks.

### SUMMARY

Embodiments of the present disclosure provide a handle for a hand tool. The handle may include at least four prongs that extend outwardly from a central point. An arcuate surface may be disposed between each of the at least four prongs. A connection member may extend outwardly from a central point perpendicularly in relation to the at least four prongs.

Each of the prongs may include fillet edges. Each prong may include an equal length. Each of the prongs may include the same angle in relation to each adjacent prong. The connection member may include a threaded outer surface to threadingly engage with the hand tool. The connection member may include a magnetic element within the connection member, where the magnetic element may magnetically engage to a magnetic component disposed within the hand tool. The hand tool may include a locking element to lock the connection member to the hand tool. The handle may include a substantially flat top surface.

The handle may include four prongs that extend outwardly at about a 90 degree angle in relation to each adjacent prong. The handle may include five prongs that extend outwardly at about a 72 degree angle in relation to each adjacent prong. Each arcuate surface may include a pair of protrusions extending from each of the arcuate surfaces wherein each pair of protrusions form a second arcuate surface between the pair of protrusions.

The present disclosure can also be viewed as providing a handle for a hand tool, where the handle includes at least four prongs extending outwardly from a central point. Each of the at least four prongs may include an arcuate surface between each of the at least four prongs. The handle may include a pair of protrusions extending from each of the arcuate surfaces, where each pair of protrusions form a second arcuate surface between the pair of protrusions. A connection member may extend outwardly from the central point perpendicularly to the at least four prongs.

Each of the at least four prongs may include at least one fillet edge. The connection member may be configured to frictionally engage with a space formed within the hand tool. The connection member may include a metallic element within the connection member, where the metallic element may magnetically engage with a magnetic component within the hand tool. The handle may include five prongs that extend at a 72 degree angle in relation to each adjacent prong. The at least four prongs may include a width that decreases as each prong extends outwardly from the center of the handle. Each of the prongs may include an equal length. The handle may include one of a thermoplastic, polyactic acid (PLA), acrylonitrile butadiene styrene (ABS), polyamide (PA), and high impact polystyrene (HIPS). The hand tool may include a ratcheting screwdriver.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a perspective view illustration of a handle in accordance with some exemplary embodiments of the present disclosure.

FIG. 2 is a perspective view illustration of a handle and a hand tool in accordance with some exemplary embodiments of the present disclosure.

FIG. 3 is a side view illustration of a handle in accordance with some exemplary embodiments of the present disclosure.

FIG. 4 is a perspective view illustration of a handle in accordance with some exemplary embodiments of the present disclosure.

FIG. 5 is an exploded view illustration of a hand tool and a handle in accordance with some exemplary embodiments of the present disclosure.

### DETAILED DESCRIPTION

The present disclosure generally relates to a handle. The handle may be engaged to a hand tool, which may include, but is not limited to, a screwdriver, ratcheting screwdriver, or wrench. The handle comprises at least four prongs extending outwardly from a central point. At least four arcuate surfaces are disposed between each of the prongs. The handle includes a connection member extending outwardly from the central point perpendicularly in relation to the at least four prongs. The connection member may be configured to engage with the hand tool.

Each arcuate surface may be configured to receive a finger of a user. The handle may allow an ergonomic fit for the hand of the user placed on the handle, such that at least four fingers of the user's hand may be placed between the prongs, and received by each of the arcuate surfaces. When the user's fingers are positioned between the prongs of the handle, the required torque that is needed to provide sufficient force to perform a given task may be reduced.

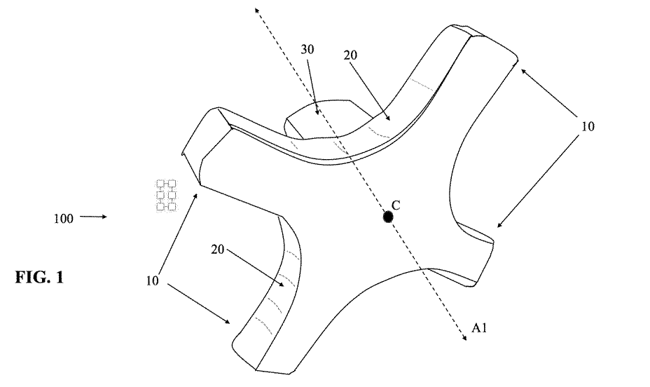

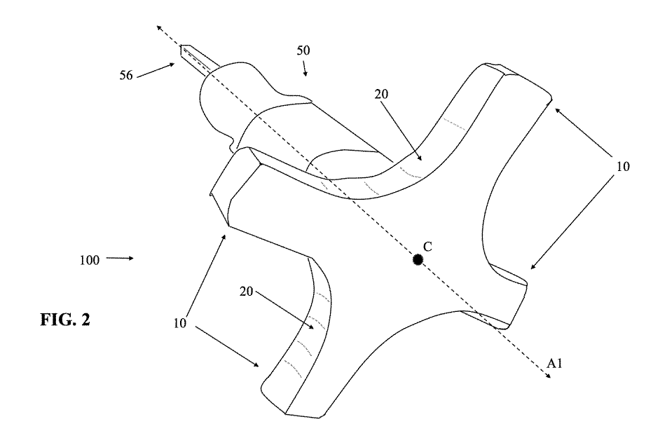

FIG. 1 illustrates a handle 100 in accordance with some exemplary embodiments of the present disclosure. The handle 100 may be configured to be engaged with a hand tool 50, as discussed further below in FIG. 2.

The handle 100 includes at least four prongs 10. As shown in FIG. 1, the handle 100 may include four prongs 10. In other embodiments, the handle 100 may include five or more prongs 10. Each prong 10 may extend outwardly from the central point C. Each prong 10 may extend outwardly from the center C in a direction perpendicular to the central axis A1. Each prong 10 may comprise a generally rectangular shape. Each prong 10 may include another suitable shape, such as, but not limited to, a substantially cylindrical or curved shape. The length of each prong 10 may be greater than the width of each prong 10. Each prong 10 may be substantially straight. Each prong 10 may decrease in width as the prong 10 extends outwardly from the center C.

The peripheral surfaces of each prong 10 may include a fillet edge. Alternatively, some or a portion of the peripheral surfaces of each prong 10 may be fillet, chamfer, or squared. For example, a first side of each prong 10 may include a fillet edge, while the second side of each prong 10 includes a chamfer edge. In another example, only the peripheral surfaces that may contact the user's hand may be filleted to provide additional comfort to the user.

As shown in FIG. 1, the handle 100 includes at least four arcuate surfaces 20. Each arcuate surface 20 is disposed between each of the prongs 10. Each arcuate surface 20 may include an arcuate, parabolic, or ‘U’ shape that is curved toward the central point C. Each of the user's fingers may be disposed near or in contact with each of the arcuate surfaces 20.

The palm or hand of the user may be disposed above or in contact with a top surface 12 of the handle 100. The handle 100 as shown in FIG. 1, for example, may provide for at least four fingers of the user to be placed on or in contact with each of the arcuate surfaces 20 with greater space between each finger without additional strain on the user's hand and wrist.

The handle 100 may include one or a combination of a thermoplastic, polyactic acid (PLA), acrylonitrile butadiene styrene (ABS), polyamide (PA), high impact polystyrene (HIPS), or another suitable material known in the industry The handle 100 or any portion thereof may be covered with a padded material, flexible rubber, plastic, or another suitable material to provide additional comfort to the user. Each prong 10 may include a length from the al point C ranging from 1 to 3 inches.

FIG. 2 is a perspective view illustration of a handle 100 engaged to a hand tool 50 in accordance with some exemplary embodiments of the present disclosure. In some embodiments, handle 100 may be configured to removably engage with a hand tool 50. Such hand tools 50 may include, but are not limited to, a screwdriver, a ratcheting screwdriver, a wrench, or another suitable hand tool known in the industry. The handle 100 may be disposed at an end of the hand tool 50 opposite the active component 56 of a hand tool 50. The active component 56 may include the driving bit of a screwdriver, for example. The handle 100 and the hand tool 50 may include a common central axis A1. In at least one embodiment, the handle 100 and the hand tool 50 may be affixed to each other to create a unitary hand tool device.

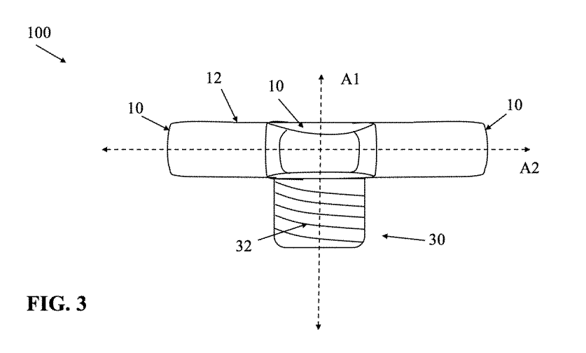

FIG. 3 is a side view illustration of a handle 100 in accordance with some exemplary embodiments of the present disclosure. The handle 100 may include at least four prongs 10, a top surface 12, and a connection member 30.

The handle 100 may include a top surface 12 that extends perpendicularly from the central axis A1. The top surface 12 and each prong 10 may extend in parallel with axis A2. Central axis A1 may be substantially perpendicular to axis A2. As shown, the top surface 12 is substantially flat. In some embodiments, the top surface 12 may be curved to provide a comfortable fit for the hand of the user. A cover material, such as flexible rubber or plastic comprising padding or cushioning may be disposed over the top surface 12 of the handle 100.

The handle 100 may include a connection member 30. The connection member 30 may be removably engaged to a shaft of a hand tool. The connection member 30 may be disposed centrally on the handle 100. The connection member 30 may extend outwardly from the handle 100, extending along central axis A1. The connection member 30 may be extend substantially perpendicular to the plurality of prongs 10 and axis A2. The connection member 30 may length of 1 to 3 inches, and a width ranging from 1 to 3 inches. The connection member 30 may include a cylindrical shape. The connection member 30 may include a rectangular or another suitable shape.

In one embodiment, the connection member 30 is configured to frictionally engage with a hand tool. In an embodiment, the connection member 30 includes a threaded periphery surface 32. The inner surface of the hand tool 50 may be threaded such that the inner surface of the hand tool 50 is threadingly engaged with the threaded periphery surface 32 of the connection member 30. In some embodiments, the periphery surface 32 may include, but is not limited to grooves or slots that allow for the periphery surface 32 to threadingly engage with the inner surface of the hand tool 50.

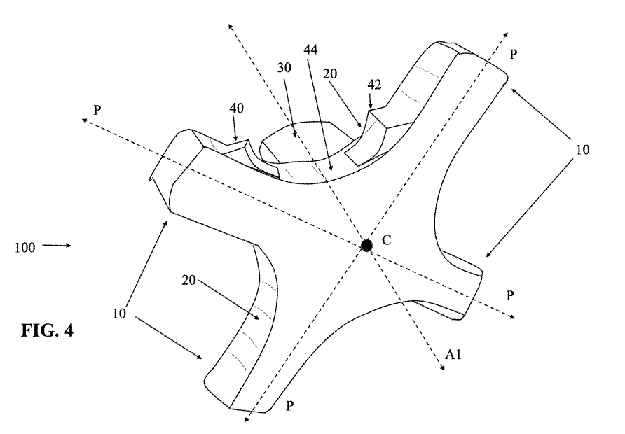

FIG. 4 is a perspective view illustration of a handle 100 in accordance with some exemplary embodiments of the present disclosure. The handle may include at least four prongs 10, at least four arcuate surfaces 20, a connection member 30. In some embodiments, the handle 100 may include a pair of protrusions 40, 42.

The pair of protrusions 40, 42 may extend outwardly from each arcuate surface 20. Each of the pair of protrusions 40, 42 may include a curved surface. The pair of protrusions 40, 42, may combine to form a second arcuate surface 44 between the pair of protrusions 40, 42. The second arcuate surface 44 may include a greater parabolic angle relative to the first arcuate surface 20. The second arcuate surface 44 may provide a surface configured to receive the finger of the user. The pair of protrusions 40, 42 extending from each arcuate surface 20 may include one or more fillet edge. The user with at least four fingers in contact with the second arcuate surface 44 may provide force to one of the pair of protrusions 40, 42 to provide torque to perform a specific task.

As shown in FIG. 4, each prong 10 may extend outwardly from the central point C of the handle 100 along axis P. Each of the prongs 10 may be equiangular to each adjacent prong 10. The length of each prong 10 may be equal. Each prong 10 may extend along an axis P such that each angle between each prong 10 is represented by the angular distance between a first prong 10 and each adjacent prong 10. The angular distance between each axis P relative to the central point C may represent the distance between each prong 10.

Each prong 10 may be co-planar on a plane perpendicular with the central axis A1. For example, each prong 10 may extend along an axis P comprising about a 72 degree angle relative to each other prong 10. In another example, each prong 10 may be disposed at about a 90 degree angle relative to one another to substantially resemble a plus-sign shape. For example, one or more of the prongs 10 may be disposed at about a 90 degree angle, i.e. each prong may comprise an angle within ten degrees of 90 degrees. In another embodiment, each of the prongs 10 extend along an axis P comprising varied angles relative to each adjacent angle to resemble the general anatomical position of many user's fingers. For example, each angle P between each of the prongs 10 may vary between 60 and 120 degrees.

Each prong 10 may be substantially straight and comprise a uniform width. In another embodiment, each prong 10 may comprise a variable width. For example, the width of each prong 10 may decrease as each prong 10 extends a greater distance from the central point C.

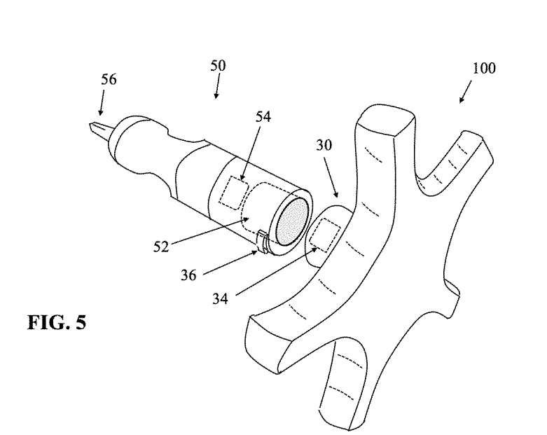

FIG. 5 is an exploded view illustration of a hand tool 50 and a handle 100 in accordance with some exemplary embodiments of the present disclosure.

In one embodiment, the handle 100 may be configured to engage to an end of the hand tool 50 to comprise a unitary hand tool piece. In another embodiment, the handle 100 may be removably engaged to the hand tool 50. One of multiple handles 100 comprising components as described herein may be removably engaged to the hand tool 50.

The handle 100 may connect to the hand tool 50 using the connection member 30. In an embodiment, the connection member 30 is sized to appropriately engage within a space 52 formed in the hand tool 50, so that the connection member 30 may frictionally engage with the hand tool 50.

In one embodiment, the connection member 30 is hollow. As shown in FIG. 5, the connection member 30 may include a magnetic material 34 disposed within the connection member 30. The magnetic material 34 may include any conventional magnetic material or blend of materials known in the industry. The hand tool 50 may include a magnetic material 54 comprising a known magnetic material with an opposing polarity to the magnetic material 34 of the connection member 30. The magnetic material 34 of the connection member 30 may be configured to magnetically engage with the magnetic material 54 of the hand tool 50.

In an embodiment, the connection member 30 may comprise a locking mechanism 36. The locking mechanism 36 may be disposed on the hand tool 50. The locking mechanism 36 may extend into the connection member 30 to frictionally engage the connection member 30 to prevent the connection member 30 from being removed from the hand tool 50. In one embodiment, the locking mechanism 36 may include a lock that may slide between a locked position and an unlocked position. The locked position may bias the connection member 30 within the hand tool 50 to prevent the connection member 30 from being removed from the hand tool 50.

In operation, the user may place their hand above the handle 100. At least four fingers of the user may contact each of the arcuate surfaces 20. In some embodiments, each of the at least four fingers may be disposed on each of the at least four second arcuate surfaces 44 formed between the pair of protrusions 40, 42 disposed on each arcuate surface 20. When the hand is placed on the handle 100, the wrist of the user may be substantially straight to avoid discomfort from the wrist of the user bending. The palm of the user may rest above the handle 100 or rest on a top surface 12 of the handle 100.

When the fingers of the user are received by the arcuate surfaces 20 of the handle 100, the user may provide torque onto the handle 100 directed around the central axis A1. The user may turn the handle 100 to perform a task, such as drive a screw into a material. The length of the prongs 10 of the handle 100 may allow for a greater mechanical advantage when rotating the handle 100, which may allow for greater force applied to the active component 56 of the hand tool 50 with a certain amount of torque provided. This may allow for less overall rotational torque to be applied to the handle 100 to provide sufficient force to perform a task, such as drive a screw into a material.

It should be emphasized that the above-described embodiments of the present disclosure, particularly, any “preferred” or “illustrative” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. A handle, comprising:
at least four prongs extending outwardly from a central point;
an arcuate surface disposed between each of the at least four prongs; and
a connection member extending outwardly from the central point perpendicularly in relation to the at least four prongs.

2. The handle of claim 1, wherein each of the at least four prongs comprise at least one fillet edge.

3. The handle of claim 1, wherein each of the prongs comprise an equal length.

4. The handle of claim 1, wherein each prong is equiangular to each adjacent prong.

5. The handle of claim 1, wherein the connection member is threadingly engaged with a hand tool.

6. The handle of claim 1, wherein the connection member comprises a magnetic element disposed within the connection member, wherein the magnetic element is configured to magnetically engage to a magnetic component disposed within a hand tool.

7. The handle of claim 1, wherein the hand tool comprises a locking element, wherein the locking element is configured to lock the connection member to a hand tool.

8. The handle of claim 1, further comprising a substantially flat top surface.

9. The handle of claim 1, further comprising four prongs extending outwardly at about a 90 degree angle in relation to each adjacent prong.

10. The handle of claim 1, comprising five prongs extending outwardly at about a 72 degree angle in relation to each adjacent prong.

11. The handle of claim 1, wherein each of the arcuate surfaces comprises a pair of protrusions extending from each of the arcuate surfaces,
wherein each pair of protrusions forms a second arcuate surface between the pair of protrusions.

12. A handle, comprising:
at least four prongs extending outwardly from a central point,
wherein each of the at least four prongs include an arcuate surface disposed between each of the at least four prongs;
a pair of protrusions extending from each of the arcuate surfaces, wherein each pair of protrusions form a second arcuate surface between the pair of protrusions; and
a connection member extending outwardly from the central point perpendicularly to the at least four prongs.

13. The handle of claim 12, wherein each of the at least four prongs comprise at least one fillet edge.

14. The handle of claim 12, wherein the connection member is configured to frictionally engage with a space formed within the hand tool.

15. The handle of claim 12, wherein the connection member comprises a metallic element disposed within the connection member, wherein the metallic element is configured to magnetically engage with a magnetic component disposed within the hand tool.

16. The handle of claim 12, further comprising five prongs comprising about a 72 degree angle in relation to each adjacent prong.

17. The handle of claim 12, wherein each of the at least four prongs comprises a width that decreases as each prong extends outwardly from the center of the handle.

18. The handle of claim 12, wherein each of the at least four prongs comprise an equal length.

19. The handle of claim 12, wherein the handle comprises one of a thermoplastic, polyactic acid (PLA), acrylonitrile butadiene styrene (ABS), polyamide (PA), and high impact polystyrene (HIPS).

20. The handle of claim 12, wherein the handle is configured to engage with a ratcheting screwdriver.
